(19) United States
(12) Patent Application Publication
(10) Pub. No.: US 2024/0355509 A1
(43) Pub. Date: Oct. 24, 2024

(54) CABLE AND COMMUNICATION SYSTEM

(71) Applicant: HUAWEI TECHNOLOGIES CO., LTD., Shenzhen (CN)

(72) Inventors: Zhaoyang TANG, Shenzhen (CN); Long SHEN, Shanghai (CN); Xianglong LIU, Shenzhen (CN); Peng CHEN, Shanghai (CN); Baohua SUN, Xi’an (CN); Gaonan ZHOU, Xi’an (CN); Wei NIU, Xi’an (CN)

(73) Assignee: HUAWEI TECHNOLOGIES CO., LTD., Shenzhen (CN)

(21) Appl. No.: 18/755,985

(22) Filed: Jun. 27, 2024

Related U.S. Application Data
(63) Continuation of application No. PCT/CN2022/140267, filed on Dec. 20, 2022.

(30) Foreign Application Priority Data
Dec. 31, 2021 (CN) 202111667743.0

(51) Int. Cl. H01B 11/18; H01Q 21/00

(52) U.S. Cl. CPC H01B 11/1869; H01B 11/1895; H01Q 21/0006

(57) ABSTRACT

A cable includes a first part and a second part. The first part includes a cable core, a metal layer, and a dielectric layer. The metal layer wraps the cable core, and the dielectric layer is sandwiched between the cable core and the metal layer. The second part includes a plurality of metal units and a dielectric unit. The plurality of metal units are spacedly disposed on the metal layer of the cable, to reduce cable's shielding on an electromagnetic wave in a specific frequency band. The cable is placed on a radiation path of an antenna. This can reduce shielding on an electromagnetic wave radiated by the antenna, to avoid distortion of an antenna pattern.

### CROSS-REFERENCE TO RELATED APPLICATIONS

This application is a continuation of International Application No. PCT/CN2022/140267, filed on Dec. 20, 2022, which claims priority to Chinese Patent Application No. 202111667743.0, filed on Dec. 31, 2021. The disclosures of the aforementioned applications are hereby incorporated by reference in their entireties.

### TECHNICAL FIELD

Embodiments relate to the communication field, and to a cable and a communication system.

### BACKGROUND

In a scenario in which array antennas are integrated for wireless communication, a coaxial cable used in the array antennas may shield radiation of the antennas. This results in pattern deterioration of the array antennas, thereby affecting communication quality. Therefore, how to design a cable to reduce cable's shielding on an electromagnetic wave and improve performance in the antenna radiation pattern becomes an urgent problem to be resolved.

### SUMMARY

Embodiments provide a cable and a communication system. A plurality of metal units are spacedly disposed, or disposed in a spaced-apart manner, on a metal layer of the cable. This can implement bandpass of an electromagnetic wave in a specific frequency band, thereby reducing cable's shielding on the electromagnetic wave in the specific frequency band. In addition, when the cable having the structure is placed on a radiation path of an antenna, shielding on an electromagnetic wave radiated by the antenna can be reduced, to avoid distortion of an antenna pattern.

According to a first aspect, a cable is provided, including a first part and a second part. The first part includes a cable core, a metal layer, and a dielectric layer. The metal layer wraps the cable core, and the dielectric layer is sandwiched between the cable core and the metal layer. The second part includes a plurality of metal units and a dielectric unit. The plurality of metal units are spacedly disposed on the metal layer, and the dielectric unit is sandwiched between the plurality of metal units and the metal layer.

Based on the foregoing solution, according to the cable provided in the embodiments, the plurality of metal units are spacedly disposed on the metal layer of the cable. This can implement bandpass of an electromagnetic wave in a specific frequency band, thereby reducing cable's shielding on the electromagnetic wave in the specific frequency band.

In addition, the cable having the structure can be placed on a radiation path of an antenna. For example, the cable is placed right above the antenna. For another example, the cable is placed on a side of the antenna. For still another example, the cable is placed right below the antenna.

It should be noted that a location relationship between the cable and the antenna is not limited, and the cable is (completely or partially) located on the radiation path of the antenna. The radiation path of the antenna is a radiation direction of an electromagnetic wave signal of the antenna.

In a possible implementation, that the plurality of metal units are spacedly disposed on the metal layer may be that the metal layer is provided with the plurality of metal units spacedly. In this implementation, the plurality of metal units may be considered as being attached to the metal layer one by one.

For example, the first part is a common cable having no bandpass function, and the second part is a plurality of unit structures attached to the outer metal layer of the common cable. Each unit structure includes a metal unit and a dielectric unit that is sandwiched between the metal unit and the metal layer.

In another possible implementation, that the plurality of metal units are spacedly disposed on the metal layer may be that an attached metal layer is first disposed on the metal layer (for example, the attached metal layer wraps the metal layer, and an attached dielectric layer is disposed between the attached metal layer and the metal layer), and the metal layer is slotted spacedly, to form the plurality of metal units. In this implementation, the plurality of metal units may be considered as being implemented by slotting the attached metal layer spacedly on the metal layer.

For example, the attached dielectric layer and the attached metal layer are sequentially disposed on the outer metal layer of the common cable having no bandpass function, to form a thickened common cable. Then, a plurality of slots are provided spacedly on the thickened common cable. A part between two adjacent slots is a unit structure, and cach unit structure includes a metal unit and a dielectric unit.

It should be noted that a method for producing the cable is not limited, provided that the cable structurally includes the first part and the second part.

In a possible implementation, a quantity of dielectric units is equal to a quantity of the metal units, and one of the dielectric units is sandwiched between one of the metal units and the metal layer. One dielectric unit and one metal unit may be considered as a unit structure.

Based on the foregoing solution, the quantity of the dielectric units is equal to the quantity of the metal units, so that one dielectric unit and one metal unit form a unit structure. This facilitates production by using the unit structure as a production unit and avoids disposing the dielectric units on the entire metal layer, thereby reducing production costs. In addition, no dielectric unit is disposed at a gap location between the metal units. This facilitates bending of the cable and avoids disposing the dielectric units on the entire metal layer, thereby reducing costs.

For example, the metal unit may be a metal sleeve. The dielectric unit is disposed on an inner wall of the metal sleeve, and a plurality of metal sleeves whose inner walls are provided with dielectric units are sleeved spacedly on the first part.

For another example, the metal unit may be a metal sleeve. A plurality of metal sleeves are sleeved spacedly on the first part, and gaps between the plurality of metal sleeves and the metal layer and air in the gaps can form a plurality of dielectric units.

“Sleeving” may be understood as that the first part passes through the plurality of metal sleeves or a hollow part of the plurality of metal sleeves provided with the dielectric units, and a part of the first part is located into the hollow part.

In a possible implementation, there is one dielectric unit, and the dielectric unit wraps the metal layer, and is disposed between the plurality of metal units and the metal layer.

Based on the foregoing solution, the dielectric unit may be an attached dielectric layer that wraps the metal layer. This can simplify a processing process.

For example, the dielectric unit is disposed on the metal layer. The dielectric unit can be considered as a whole, and the quantity of the metal units does not need to be considered to dispose the dielectric unit.

It should be noted that, to stably dispose the metal unit on the metal layer, the dielectric unit may be made of a dielectric instead of being naturally formed by an air gap. A dielectric for making the dielectric unit may be a Teflon material, or may be another insulation material, for example, plastic, ceramic, or glass.

In a possible implementation, one of the plurality of metal units is disposed on a first annular area of the metal layer, and the metal unit completely or partially covers the first annular area. In a possible implementation, a shape of the metal unit includes a circular ring shape or a spiral shape.

Based on the foregoing solution, a metal unit may be disposed on an annular area of the metal layer, but the metal unit may not need to completely wrap the annular area. A specific form of the metal unit is not limited excessively. This can improve flexibility of the solution.

In a possible implementation, one of the plurality of metal units is disposed on a first annular area of the metal layer, and the metal unit completely covers the first annular area.

For example, the metal unit is in the circular ring shape. The metal unit in the circular ring shape is sleeved on the metal layer, and can completely cover an area in which the metal unit is located.

For example, the metal unit is a circular metal ring. For the circular metal ring, a length is greater than or equal to 10 mm and less than or equal to 40 mm, and a thickness is greater than or equal to 5 mm and less than or equal to 30 mm. A gap between two adjacent circular metal rings is greater than or equal to 5 mm and less than or equal to 15 mm.

It should be noted that a size of the circular metal ring and a size of the gap between adjacent circular metal rings may be designed based on an operating frequency band of the cable.

For another example, the metal unit is in a polygonal ring shape (for example, a regular hollow polyhedron). The metal unit in the polygonal ring shape is sleeved on the metal layer, and can completely cover an area in which the metal unit is located.

For example, the metal unit is a polygonal metal ring. For the polygonal metal ring, a length (or referred to as a height or a width) is greater than or equal to 10 mm and less than or equal to 40 mm, and a thickness is greater than or equal to 5 mm and less than or equal to 30 mm. A gap between two adjacent polygonal metal rings is greater than or equal to 5 mm and less than or equal to 15 mm.

It should be noted that a size of the polygonal metal ring and a size of the gap between adjacent polygonal metal rings may be designed based on an operating frequency band of the cable.

For still another example, the metal unit is in an irregular ring shape (for example, an irregular hollow body). The metal unit in the irregular ring shape is sleeved on the metal layer, and can completely cover an area in which the metal unit is located.

In another possible implementation, one of the plurality of metal units is disposed on a first annular area of the metal layer, and the metal unit partially covers the first annular area.

For example, the metal unit is in the spiral shape. The metal unit in the spiral shape is sleeved on the metal layer, and can partially cover an area in which the metal unit is located.

For example, the metal unit is a spiral metal ring. For the spiral metal ring, a length (or referred to as a height or a width) is greater than or equal to 10 mm and less than or equal to 40 mm, and a thickness is greater than or equal to 5 mm and less than or equal to 30 mm. A gap between two adjacent spiral metal rings is greater than or equal to 5 mm and less than or equal to 15 mm.

It should be noted that a size of the spiral metal ring and a size of the gap between adjacent spiral metal rings may be designed based on an operating frequency band of the cable.

For another example, the metal unit is in a semicircular ring shape.

For still another example, the metal unit is in a circular ring shape having a hollow area.

For still another example, the metal unit is partially in a circular ring shape and partially in a spiral shape.

For example, the metal unit may be made of copper, or may be made of a metal alloy, or may be made of another metal material, for example, aluminum or silver.

In a possible implementation, that the plurality of metal units are spacedly disposed on the metal layer includes: The plurality of metal units are equally spaced on the metal layer.

Based on the foregoing solution, the plurality of metal units may be equally spaced on the metal layer (112), to improve bandpass performance of the cable.

In a possible implementation, a gap between any two adjacent metal units in the plurality of metal units is greater than or equal to 5 mm and less than or equal to 15 mm.

Based on the foregoing solution, the gap between the any two adjacent metal units in the plurality of metal units may be adjusted based on a requirement (for example, the operating frequency of the cable), instead of merely being a fixed value. This facilitates use of the cable to meet different requirements.

For example, when the operating frequency of the cable is 1400 MHz to 2690 MHz, the gap between any two adjacent metal units is greater than or equal to 10 mm and less than or equal to 15 mm.

For another example, when the operating frequency of the cable is 3300 MHz to 3800 MHz, the gap between any two adjacent metal units is greater than or equal to 8 mm and less than or equal to 14 mm.

For still another example, when the operating frequency of the cable is 4800 MHz to 5000 MHz, the gap between any two adjacent metal units is greater than or equal to 5 mm and less than or equal to 10 mm.

For still another example, when the operating frequency of the cable is 6425 MHz to 7125 MHz, the gap between any two adjacent metal units is greater than or equal to 5 mm and less than or equal to 8 mm.

In addition, it may be understood that, when the quantity of the dielectric units is equal to the quantity of the metal units, a gap between two adjacent dielectric units is equal to a gap between two adjacent metal units corresponding to the two adjacent dielectric units. A metal unit corresponding to a dielectric unit may be understood as that the dielectric unit is sandwiched between the metal unit and the metal layer.

In a possible implementation, a length of the metal unit is related to the operating frequency band of the cable. The operating frequency band of the cable includes at least one of the following: 1400 MHz to 2690 MHz, 3300 MHz to 3800 MHz, 4800 MHz to 5000 MHz, or 6425 MHz to 7125 MHz.

Based on the foregoing solution, there is a high probability that the operating frequency band of the cable may be one of 1400 MHz to 2690 MHz, 3300 MHz to 3800 MHz, 4800 MHz to 5000 MHz, or 6425 MHz to 7125 MHz. In this way, the designed cable can meet a specific operating frequency requirement, and possible operating frequency bands of the cable are listed to facilitate use of the cable.

In addition, it may be understood that when the quantity of the dielectric units is equal to the quantity of the metal units, a length of a dielectric unit is equal to a gap between metal units corresponding to the dielectric unit.

In a possible implementation, for the metal unit, the length is greater than or equal to 10 mm and less than or equal to 40 mm, and a thickness is greater than or equal to 5 mm and less than or equal to 30 mm.

Based on the foregoing solution, a size of the metal unit may be adjusted based on a requirement (for example, the operating frequency of the cable), instead of merely being a fixed value. This facilitates use of the cable to meet different requirements.

For example, when the operating frequency of the cable is 1400 MHz to 2690 MHz, for the metal unit, the length is greater than or equal to 28 mm and less than or equal to 40 mm, and the thickness is greater than or equal to 14 mm and less than or equal to 30 mm.

For another example, when the operating frequency of the cable is 3300 MHz to 3800 MHz, for the metal unit, the length is greater than or equal to 16 mm and less than or equal to 25 mm, and the thickness is greater than or equal to 8 mm and less than or equal to 14 mm.

For still another example, when the operating frequency of the cable is 4800 MHz to 5000 MHz, for the metal unit, the length is greater than or equal to 10 mm and less than or equal to 18 mm, and the thickness is greater than or equal to 5 mm and less than or equal to 12 mm.

For still another example, when the operating frequency of the cable is 6425 MHz to 7125 MHz, for the metal unit, the length is greater than or equal to 10 mm and less than or equal to 15 mm, and the thickness is greater than or equal to 5 mm and less than or equal to 8 mm. In a possible implementation, any two of the plurality of metal units are the same.

In addition, it may be understood that, when the quantity of the dielectric units is equal to the quantity of the metal units, at least two of the plurality of dielectric units are the same. In a possible implementation, the cable includes a coaxial cable.

In a possible implementation, the plurality of metal units are a plurality of attached metal layers spacedly disposed on the metal layer.

According to a second aspect, a communication system is provided, including the cable according to the first aspect and a first antenna array. The cable is located on a radiation path of the first antenna array.

Based on the foregoing solution, the cable provided in the embodiments can implement bandpass of an electromagnetic wave in a specific frequency band and reduce cable's shielding on the electromagnetic wave in the specific frequency band. Therefore, when the cable is located on the radiation path of the first antenna array, shielding, by the cable, on an electromagnetic wave radiated by the first antenna array can be reduced, to implement pattern preservation of the first antenna array.

In a possible implementation, the communication system further includes a second antenna array. The first antenna array includes a first receive antenna module, a low noise amplification module, and a power supply module. The second antenna array includes a second receive antenna module.

For example, the first antenna array is an active antenna array, and the second antenna array is a passive antenna array.

### BRIEF DESCRIPTION OF THE DRAWINGS

FIG. 1(a) is a diagram of a scenario to which embodiments are applicable;

FIG. 1(c) is a diagram of a scenario to which embodiments are applicable;

FIG. 1(c) is a diagram of a scenario to which embodiments are applicable;

FIG. 1(d) is a diagram of a scenario to which embodiments are applicable;

FIG. 2 is a diagram of a cable according to the embodiments;

FIG. 3 is a diagram of another cable according to the embodiments;

FIG. 4(a) is a diagrams of a unit structure according to an embodiment;

FIG. 4(b) is a diagrams of a unit structure according to an embodiment;

FIG. 4(c) is a diagrams of a unit structure according to an embodiment;

FIG. 4(d) is a diagrams of a unit structure according to an embodiment;

FIG. 4(c) is a diagrams of a unit structure according to an embodiment;

FIG. 4(f) is a diagrams of a unit structure according to an embodiment;

FIG. 5 is a sectional view of a unit structure disposed on a metal layer in the embodiments;

FIG. 6 is a side view of a unit structure disposed on a metal layer in the embodiments;

FIG. 7 is a schematic of an equivalent circuit in which a unit structure is disposed on a metal layer in the embodiments;

FIG. 8 is a diagram of still another cable according to an embodiment;

FIG. 9(a) is a diagram of still another cable according to an embodiment;

FIG. 9(b) is a diagram of still another cable according to an embodiment;

FIG. 10(a) is a diagram of gaps between unit structures;

FIG. 10(b) is a diagram of gaps between unit structures;

FIG. 11(a) is a diagrams of a size of a unit structure;

FIG. 11(b) is a diagrams of a size of a unit structure;

FIG. 12(a) is a diagram of a horizontal location of a unit structure; and

FIG. 12(b) is a diagram of a horizontal location of a unit structure.

### DETAILED DESCRIPTION OF EMBODIMENTS

The following describes the solutions of embodiments with reference to the accompanying drawings.

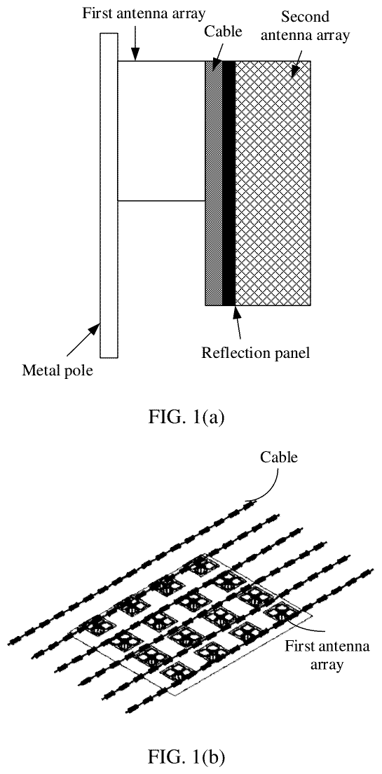

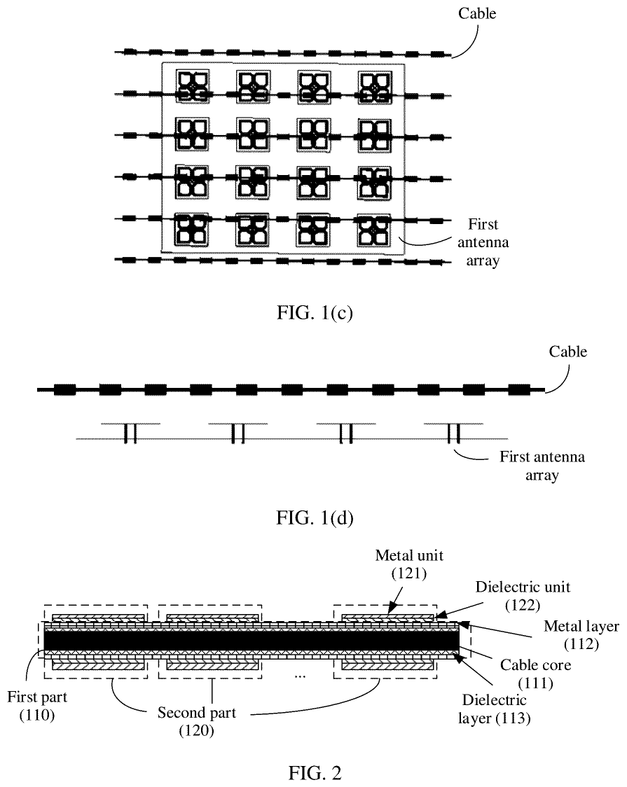

For ease of understanding embodiments, scenarios to which embodiments may be applicable are briefly described first with reference to FIG. 1(a) to FIG. 1(d).

For example, FIG. 1(a) to FIG. 1(d) show scenarios to which embodiments may be applicable. It can be understood from FIG. 1(a) that a cable can be used in cooperation with an array antenna.

It can be understood from FIG. 1(a) that the scenario shown in FIG. 1(a) includes a metal pole for mounting an antenna, a first antenna array, a cable, a reflection panel, and a second antenna array. The metal pole may be a metal pole fastened at a location and is configured to mount an antenna. The metal pole may alternatively be in another form. This is not limited.

For example, the first antenna array may be an active antenna array. The active antenna array may be understood as an antenna system formed by many same active antennas arranged according to a specific rule. An active antenna is integrated with a receive antenna module, a low noise amplification module, and a power supply module. The cable is the cable provided in the embodiments and is configured to transmit a signal to a passive antenna array. The cable is described in detail in the following, and details are not described herein. The reflection panel is a reflection panel of the passive antenna array and is configured to increase strength of a reflected or received signal. For example, the reflection panel is a frequency selective surface (FSS) reflection panel that has a function of reflecting an electromagnetic wave radiated by a passive antenna and has a function of transmitting an electromagnetic wave radiated by an active antenna array.

For example, the second antenna array may be a passive antenna array. The passive antenna array is an antenna provided without an active component.

It should be noted that specific structures of the foregoing metal pole, the first antenna array, the reflection panel, and the second antenna array are not limited. For details, refer to descriptions in a current related technology.

It can be understood from FIG. 1(a) that the cable is sandwiched between the first antenna array and the second antenna array, and for example, the cable is sandwiched between the first antenna array and a reflection panel of the second antenna array.

For a more intuitive understanding of a location relationship between the cable and the first antenna array, descriptions are provided with reference to FIG. 1(b) to FIG. 1(d).

With reference to FIG. 1(b) to FIG. 1(d), it can be understood that, in a possible implementation, the cable is located above the first antenna array. It should be noted that FIG. 1(b) to FIG. 1(d) merely show an example of a location relationship between the cable and the first antenna array, and do not constitute any limitation on the scope of embodiments. In embodiments, the cable may alternatively be located below, on a side, or in another direction of the first antenna array, and a part or all of the cable is located on a radiation path of the first antenna array.

It may be understood that, for a common cable, when the common cable is located on a radiation path of the first antenna array, the cable shields an electromagnetic wave radiated by the active antenna array. This results in pattern deterioration of the first array antenna, thereby affecting communication quality.

According to the cable provided in the embodiments, on a premise of transmitting a signal to the second antenna array, shielding, by the cable, on the electromagnetic wave radiated by the first antenna array can be reduced, to implement pattern preservation of the first antenna array.

It should be understood that FIG. 1(a) to FIG. 1(d) are merely an example for describing the scenarios to which the cable provided in the embodiments are applicable, and do not constitute any limitation on their scope. The embodiments can be further applied to another scenario. For example, the cable is used in cooperation with another communication device.

For ease of understanding of the solutions in embodiments, before the solutions in embodiments are described, some terms or concepts in embodiments briefly described first.

### 1. Array Antenna

The array antenna is an antenna system formed by many same antennas (for example, symmetric antennas) arranged according to a specific rule, and is also referred to as an antenna array. Generally, an independent unit of an antenna array is referred to as an array element or an antenna unit. Array elements arranged on a straight line or a plane form a straight line array or a planar array.

### 2. Antenna Pattern

The antenna pattern may also be referred to as a radiation pattern (radiation pattern) of an antenna, a far-field pattern of an antenna, or the like. The so-called antenna pattern is a graph in which relative field strength (a normalized modulus value) of a radiation field changes with a direction at a specific distance from the antenna, and can be represented by using two plane patterns that are perpendicular to each other in a maximum radiation direction of the antenna. The antenna pattern may be classified into a horizontal plane pattern and a vertical plane pattern.

### 3. Cable

The cable is a power or signal transmission apparatus, and can be formed by several or several groups of conductors.

### 4. Coaxial Cable

The coaxial cable is a type of wire and signal transmission line, manufactured with four layers of materials. An innermost layer is a conductive copper wire, and the wire is surrounded by a plastic layer (used as an insulator or dielectric). The insulator is surrounded by a thin mesh conductor (which can be copper or an alloy). An insulation material at an outermost layer of the conductor is used as an outer surface.

The coaxial cable may be configured to transmit an analog signal and a digital signal and is applicable to various applications such as television transmission, long-distance call transmission, a short-distance connection between computer systems, and a local area network. The coaxial cable, as an approach of transmitting television signals to thousands of households, is developing rapidly for cable televisions. A cable television system can bear dozens or even hundreds of television channels, and a transmission range of the cable television system can be tens of kilometers. The coaxial cable is an important part of a long-distance call network for a long time.

### 5. FSS

The FSS is a two-dimensional periodic array structure. The FSS may be a spatial filter, which interacts with an electromagnetic wave to reflect an obvious bandpass or band-stop filtering characteristic. The FSS is widely used in microwave, infrared, and visible light bands because of a specific frequency selection function of the FSS.

The foregoing describes, with reference to FIG. 1(a) to FIG. 1(d), the scenarios to which embodiments are applicable, and also briefly describes the basic concepts in the embodiments. The following describes in detail a cable and a communication system with reference to the accompanying drawings.

It should be noted that, “first”, “second”, and various numerals (for example, “#1” and “#2”) shown are merely for ease of description, and are used to distinguish between objects, but are not intended to limit the scope of embodiments, for example, used to distinguish between different metal units, and are not for describing a particular order or sequence. It should be understood that the objects described in such a way are interchangeable in a proper circumstance, so that a solution other than that in embodiments can be described.

The following describes in detail the cable provided in the embodiments with reference to the accompanying drawings.

The embodiments provide a cable, including a first part (110) and a second part (120).

In an embodiment, the first part (110) includes a cable core (111), a metal layer (112), and a dielectric layer (113). The metal layer (112) wraps the cable core (111), and the dielectric layer (113) is sandwiched between the cable core (111) and the metal layer (112).

The second part (120) includes a plurality of metal units (121) and a dielectric unit (122). The plurality of metal units (121) are spacedly disposed on the metal layer (112), and the dielectric unit (122) is sandwiched between the plurality of metal units (121) and the metal layer (112).

In a possible implementation, that the plurality of metal units (121) are spacedly disposed on the metal layer (112) may be that the metal layer (112) is provided with the plurality of metal units (121) spacedly. In this implementation, the plurality of metal units (121) may be considered as being attached to the metal layer (112) one by one.

For example, the first part (110) is a common cable (or referred to as a conventional cable), and a second part (120) is a plurality of unit structures attached to the outer metal layer (112) of the common cable. Each unit structure includes a metal unit (121) and a dielectric unit (122). In another possible implementation, that the plurality of metal units (121) are spacedly disposed on the metal layer (112) may be that an attached metal layer is first disposed on the metal layer (112) (for example, the attached metal layer wraps the metal layer (112), and an attached dielectric layer is disposed between the attached metal layer and the metal layer (112)), and the metal layer is slotted spacedly, to form the plurality of metal units (121). In this implementation, the plurality of metal units (121) may be considered as being implemented by slotting the attached metal layer spacedly on the metal layer (112).

For example, the attached dielectric layer and the attached metal layer are sequentially disposed on the outer metal layer (112) of the common cable having no bandpass function, to form a thickened common cable. Then, a plurality of slots are provided spacedly on the thickened common cable. A part between two adjacent slots is a unit structure, and each unit structure includes a metal unit (121) and a dielectric unit (122).

It should be noted that a method for producing the cable is not limited, provided that the cable structurally includes the first part (110) and the second part (120).

It can be understood from the foregoing basic concepts that the FSS has a specific frequency selection function. According to the cable provided in the embodiments, the plurality of metal units (121) are spacedly disposed on the metal layer (112) of the cable. This can implement bandpass of an electromagnetic wave in a specific frequency band, thereby reducing cable's shielding on the electromagnetic wave in the specific frequency band.

In addition, when the cable including the first part (110) and the second part (120) is placed on a radiation path of an antenna, shielding on an electromagnetic wave radiated by the antenna can be reduced, to avoid distortion of an antenna pattern. The following describes, with reference to a specific example, how to avoid the distortion of the antenna pattern. Details are not described herein.

It should be noted that a scenario to which the cable is applicable is not limited in embodiments. When the cable including the first part (110) and the second part (120) is used in cooperation with another electromagnetic wave device that can radiate a specific frequency band (for example, the cable is located on a radiation path of the device), cable's shielding on an electromagnetic wave in the specific frequency band can be reduced.

In a possible implementation, a quantity of dielectric units (122) is equal to a quantity of the metal units (121), and one of the dielectric units (122) is sandwiched between one of the metal units (121) and the metal layer (112).

For example, FIG. 2 is a diagram of a cable according to the embodiments. It can be understood from FIG. 2 that one dielectric unit (122) and one metal unit (121) may be considered as a unit structure. The second part (120) includes a plurality of unit structures. The plurality of unit structures are spacedly disposed on the metal layer (112). Any two of the unit structures are the same.

It should be noted that, when one dielectric unit (122) and one metal unit (121) form a unit structure, no dielectric unit (122) is disposed at a gap location between the metal units (121). This facilitates bending of the cable and avoids disposing the dielectric units (122) on the entire metal layer (112), thereby reducing costs.

For example, the metal unit (121) may be a metal sleeve. The dielectric unit (122) is disposed on an inner wall of the metal sleeve, and a plurality of metal sleeves whose inner walls are provided with dielectric units (122) are sleeved spacedly on the metal layer (112).

For another example, the metal unit (121) may be a metal sleeve. A plurality of metal sleeves are sleeved spacedly on the first part (110), and gaps between the plurality of metal sleeves and the metal layer (112) and air in the gaps can form a plurality of dielectric units (122).

In another possible implementation, there is one dielectric unit (122), and the dielectric unit (122) wraps the metal layer (112) and is disposed between the plurality of metal units (121) and the metal layer (112). That the plurality of metal units (121) are spacedly disposed on the metal layer (112) includes: The plurality of metal units (121) are spacedly disposed on the dielectric unit (122). The second part (120) includes a plurality of metal units (121) and a dielectric unit (122).

For example, FIG. 3 is a diagram of another cable according to the embodiments. It can be understood from FIG. 3 that a dielectric unit (122) is disposed on a metal layer (112). The dielectric unit (122) may be considered as a whole, and a quantity of metal units (121) does not need to be considered.

It should be noted that, when there is one dielectric unit (122), a processing process can be simplified.

In addition, it should be noted that, to stably dispose a metal unit (121) on the metal layer (112), the dielectric unit (122) may be made of a dielectric instead of being naturally formed by an air gap. A dielectric for making the dielectric unit (122) may be a Teflon material, or may be another insulation material, for example, plastic, ceramic, or glass.

In a possible implementation, one of the plurality of metal units (121) is disposed on a first annular area of the metal layer (112), and the metal unit (121) completely covers the first annular arca.

For example, the metal unit (121) is in a circular ring shape. The metal unit (121) in the circular ring shape is sleeved on the metal layer (112) and can completely cover an area in which the metal unit (121) is located.

For another example, the metal unit (121) is a regular hollow polyhedron (for example, a hollow cuboid, a hollow pentagon, or a hollow hexagon), and the metal unit (121) in the regular hollow polyhedron shape is sleeved on a metal layer (112) and can completely cover an area in which the metal unit (121) is located.

For still another example, the metal unit (121) is an irregular hollow body (for example, a structure body with an irregular outer surface and a cylindrical inner surface), and the metal unit (121) in the irregular hollow body shape is sleeved on a metal layer (112) and can completely cover an area in which the metal unit (121) is located.

It should be noted that, in this implementation, in the embodiments, a shape of the ring metal unit (121) disposed on the first annular area of the metal layer (112) is not limited, provided that the metal unit (121) can completely cover the first annular area.

In addition, a hollow part of a hollow metal unit (121) is not necessarily cylindrical and may be determined based on a shape of the first part (110) of the cable. For example, a first part (110) of a cable is cylindrical, and a hollow part of a hollow metal unit (121) is cylindrical. For another example, a first part (110) of a cable is a hexagonal column, and a hollow part of a ring metal unit (121) is a hexagonal column. Examples are not given one by one for description herein.

In another possible implementation, one of the plurality of metal units (121) is disposed on a first annular area of the metal layer (112), and the metal unit (121) partially covers the first annular area.

For example, the metal unit (121) is in a spiral shape. The metal unit (121) in the spiral shape is sleeved on the metal layer (112) and can partially cover an area in which the metal unit (121) is located.

For another example, the metal unit (121) is in a semicircular ring shape.

For still another example, the metal unit (121) is in a circular ring shape having a hollow area.

For still another example, the metal unit (121) is partially in a circular ring shape and partially in a spiral shape.

It should be noted that, in this implementation, in embodiments, a specific shape of the ring metal unit (121) disposed on the first annular area of the metal layer (112) is not limited, provided that the ring metal unit (121) partially covers the first annular area.

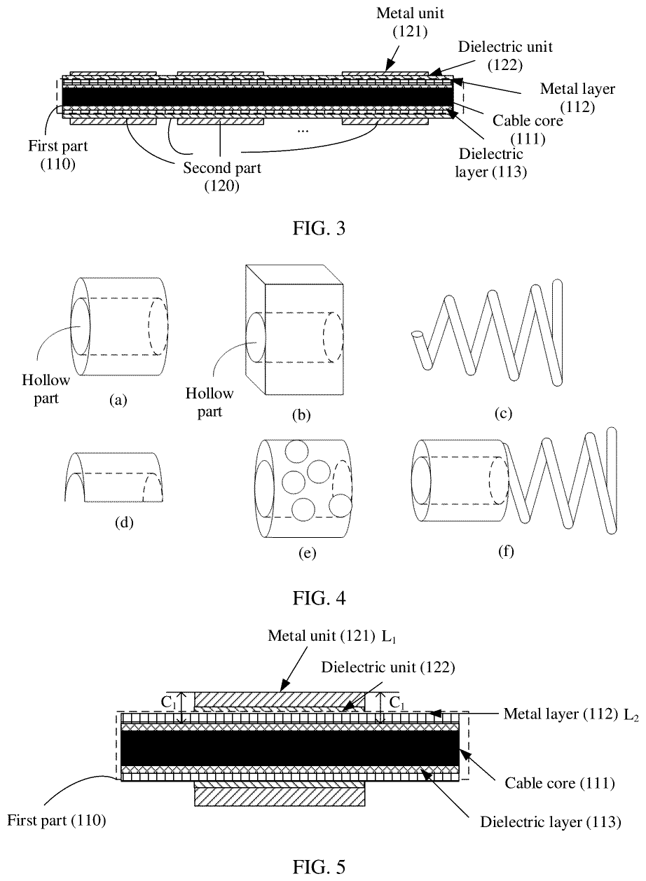

For ease of understanding, the following briefly describes a possible form of a unit structure, with reference to FIG. 4, by using an example in which one metal unit (121) and one dielectric unit (122) form a unit structure (for example, a shape of the dielectric unit (122) is the same as a shape of the metal unit (121), and the dielectric unit (122) is disposed on an inner surface of the metal unit (121)). Herein, (a) to (f) in FIG. 4 are diagrams of unit structures according to an embodiment.

It can be understood from (a) to (f) in FIG. 4 that the unit structure formed by the dielectric unit (122) and the metal unit (121) may have a plurality of forms of shapes.

A shape of a unit structure shown in (a) in FIG. 4 is a circular ring shape (for example, a hollow cylinder), and the foregoing metal unit (121) is in a circular ring shape. The metal unit (121) in the circular ring shape is sleeved on a first part (110), and the metal unit (121) of the circular ring can completely cover an area (for example, the foregoing first area) in which the metal unit (121) is located.

A shape of a unit structure shown in (b) in FIG. 4 is a hollow cuboid, and the foregoing metal unit (121) is in a hollow cuboid shape. The metal unit (121) in the hollow cuboid shape is sleeved on a first part (110), and the metal unit (121) of the hollow cuboid can completely cover an area (for example, the foregoing first area) in which the metal unit (121) is located.

Optionally, in addition to the hollow cuboid shown in (b) in FIG. 4, after simple extension, a shape of a unit structure may be a regular hollow polyhedron (for example, a hollow pentagon or a hollow hexagon). A metal unit (121) in the regular hollow polyhedron shape is sleeved on a first part (110), and the metal unit (121) in the regular hollow polyhedron shape can completely cover an area (for example, the foregoing first arca) in which the metal unit (121) is located.

Optionally, in addition to the hollow cuboid shown in (b) in FIG. 4, after simple extension, a shape of a unit structure may be an irregular hollow body (for example, a structure body with an irregular outer surface and a cylindrical inner surface). A metal unit (121) in the irregular hollow body shape is sleeved on a first part (110), and the metal unit (121) in the irregular hollow body shape can completely cover an area (for example, the foregoing first area) in which the metal unit (121) is located.

Optionally, in addition to the hollow part, of the metal unit (121) shown in (a) in FIG. 4 and (b) in FIG. 4, which is a cylinder, the hollow part of the metal unit (121) may alternatively be a column in another shape (for example, a pentagonal column or a hexagon column).

A shape of a unit structure shown in (d) in FIG. 4 is in a semicircular ring shape, and the foregoing metal unit (121) is in a semicircular ring shape. The metal unit (121) in the semicircular ring shape is disposed on a first annular area of a first part (110), and the metal unit (121) in the semicircular ring shape cannot completely cover the first annular area.

Optionally, in addition to the semicircular ring shape shown in (d) in FIG. 4, after simple extension, a shape of a unit structure may be a structure with a regular or irregular outer surface and a semi-cylindrical inner surface.

A shape of a unit structure shown in (c) in FIG. 4 is in a circular ring shape having a hollow area, and the foregoing metal unit (121) is in a circular ring shape having a hollow area. The metal unit (121) in the circular ring shape having the hollow area is disposed on a first annular area of a first part (110), and the metal unit (121) in the circular ring shape having the hollow area cannot completely cover the first annular area.

Optionally, in addition to the circular ring shape having the hollow area shown in (c) in FIG. 4, after simple extension, a shape of a unit structure may be a regular hollow body or an irregular hollow body having a hollow area.

(f) in FIG. 4 shows a unit structure that is partially in a spiral shape and partially in a circular ring shape.

Optionally, in addition to the unit structure that is partially in the spiral shape and partially in the circular ring shape as shown in (f) in FIG. 4, the unit structure may alternatively be another unit structure including a plurality of shapes, for example, including a circular ring shape and a semicircular ring shape.

It should be noted that (a) to (f) in FIG. 4 are merely examples of possible forms of the unit structure, and do not constitute any limitation on the scope of the embodiments. For example, a dielectric unit (122) in a unit structure may be slightly greater than a metal unit (121), and for another example, a metal unit (121) in a unit structure may be slightly greater than a dielectric unit (122). Examples are not given one by one for description herein.

It can be understood from the foregoing description that the plurality of metal units (121) are spacedly disposed on the metal layer (112) of the cable. This can implement bandpass of an electromagnetic wave in a specific frequency band. The specific frequency band may be understood as an operating frequency band of the cable. In other words, different cables can be designed to meet different operating frequency band requirements.

For example, a size (for example, a length or a thickness) of the foregoing metal unit (121) is related to the operating frequency band of the cable, or a size of the metal unit (121) may be designed based on an operating frequency band requirement of the cable.

For case of understanding, the following describes in detail a relationship between the size of the metal unit (121) and the operating frequency band of the cable, with reference to FIG. 5 to FIG. 7, by using an example in which a unit structure formed by a metal unit (121) and a dielectric unit (122) is in the shape shown in (a) in FIG. 4.

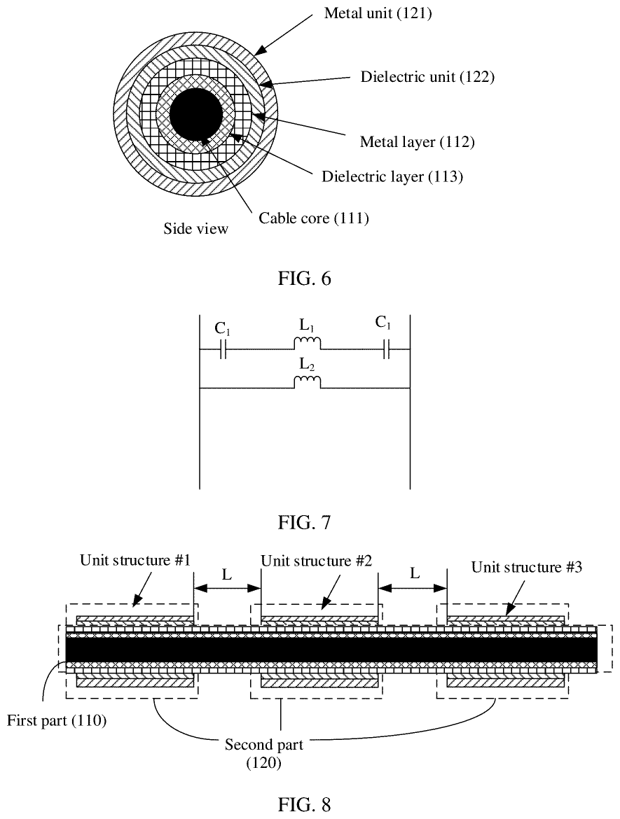

FIG. 5 is a sectional view of a unit structure disposed on a metal layer (112). FIG. 6 is a side view of a unit structure disposed on a metal layer (112).

It can be understood from FIG. 5 that the metal unit (121) and the metal layer (112) work together and are equivalent to a capacitor C₁, the metal layer (112) is equivalent to an inductor L₂, and the metal unit (121) is equivalent to an inductor L₁.

FIG. 7 is a schematic of an equivalent circuit in which the unit structure is disposed on the metal layer (112) as shown in FIG. 5. It can be understood from FIG. 7 that the unit structure is disposed on the metal layer (112), and this is equivalent to a series-parallel circuit structure. A series resonance frequency f1 and a parallel resonance frequency f2 are generated. The series resonance frequency and the parallel resonance frequency satisfy the following formula:

$${f}_{1} = \frac{1}{2 π \sqrt{2 {L}_{1} {C}_{1}}} \\ {f}_{2} = \frac{1}{2 π \sqrt{{L}_{2} ( {L}_{1} + 2 \frac{1}{{C}_{1}} )}}$$

Herein, f₁ indicates the series resonance frequency, f₂ indicates the parallel resonance frequency, L₁ is determined by a length of the metal unit (121), L₂ is determined by a length of the metal layer (112), and C₁ is determined by a radius of the metal unit (121) (for example, a thickness of the metal layer (112), the dielectric unit (122), or the metal unit (121)).

It can be understood from FIG. 5 to FIG. 7 that different operating frequency bands requirements of the cable can be met by designing the size of the metal unit (121).

In a possible implementation, a size of the metal unit (121) is designed, so that an operating frequency band of the cable is f1 to f2, where f1 indicates a lowest operating frequency of the cable, and f2 indicates a highest operating frequency of the cable. In this case, the cable provided in the embodiments basically does not shield a frequency between f1 and f2 (for example, a frequency that is greater than or equal to f1 and less than or equal to f2).

In another possible implementation, a size of the metal unit (121) is designed, so that an operating frequency band of the cable is less than or equal to f1 and greater than or equal to f2, where f1 is less than f2. In this case, the cable provided in the embodiments basically does not shield a frequency that is less than or equal to f1 and greater than or equal to f2 (for example, a frequency that is greater than or equal to f1 and less than or equal to f2).

It should be noted that the foregoing merely describes an example in which the operating frequency band of the cable provided in the embodiments is related to the size of the metal unit (121), and does not constitute any limitation on the scope of the embodiments. Cables with different operating frequency bands can be designed based on requirements. Examples are not given one by one for description herein

In addition, when a quantity of dielectric units (122) is equal to a quantity of metal units (121), a size of the dielectric unit (122) is also related to a needed operating frequency band.

Further, an effect of the cable on bandpass of an electromagnetic wave in a specific frequency band can be improved in the following manners.

Manner 1: The plurality of metal units (121) are equally spaced on the metal layer (112).

For ease of understanding, the following describes, with reference to FIG. 8, how a plurality of unit structures are equally spaced on the metal layer (112) by using an example in which a unit structure formed by a metal unit (121) and a dielectric unit (122) is in the shape shown in (a) in FIG. 4. FIG. 8 is a diagram of still another cable according to an embodiment.

It can be understood from FIG. 8 that a gap between any two adjacent unit structures is L (as shown in FIG. 8, a gap between a unit structure #1 and a unit structure #2 that are adjacent is L, and a gap between the unit structure #2 and a unit structure #3 is L).

Manner 2: A gap between the metal units (121) is reduced.

As many metal units (121) as possible may be disposed on the cable of a specific length, to improve the effect of the cable on bandpass of the electromagnetic wave in the specific frequency band.

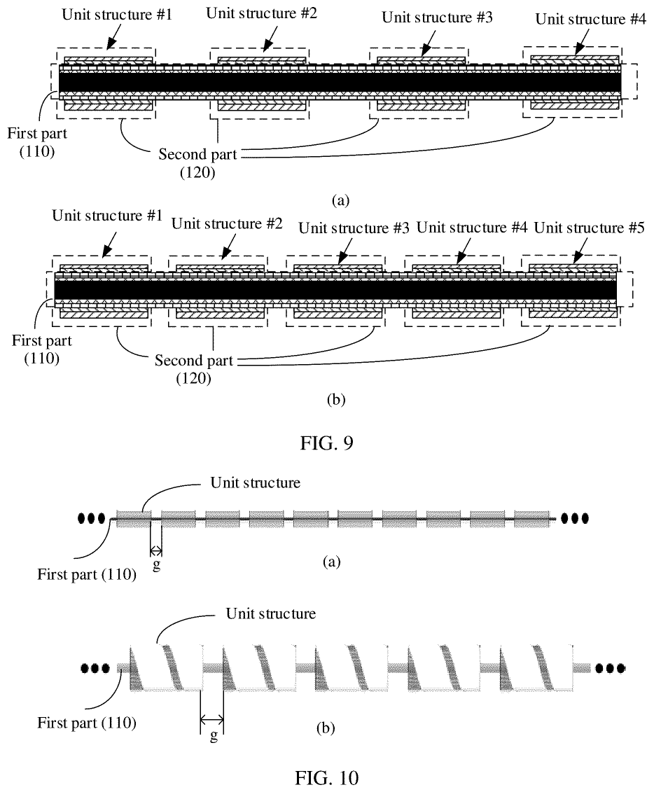

For ease of understanding, the following uses an example in which a unit structure formed by a metal unit (121) and a dielectric unit (122) is in the shape shown in (a) in FIG. 4, and describes, with reference to (a) and (b) in FIG. 9, how to improve the effect of the cable on bandpass of the electromagnetic wave in the specific frequency band by reducing the gap between the metal units (121). Herein, (a) and (b) in FIG. 9 are diagrams of still another cable according to an embodiment.

It can be understood from (a) and (b) in FIG. 9 that cable lengths and sizes of unit structures shown in (a) and (b) in FIG. 9 are the same, but a quantity of unit structures disposed in (a) in FIG. 9 is less than a quantity of unit structures disposed in (b) in FIG. 9, or a gap between unit structures disposed in (a) in FIG. 9 is greater than a gap between unit structures disposed in (b) in FIG. 9. In a possible implementation, a gap between any two adjacent metal units (121) in a plurality of metal units (121) is greater than or equal to 5 mm and less than or equal to 15 mm. When a quantity of dielectric units (122) is equal to a quantity of metal units (121), a gap between any two adjacent dielectric units (122) in the plurality of dielectric units (122) is greater than or equal to 5 mm and less than or equal to 15 mm.

For example, one metal unit (121) and one dielectric unit (122) form a unit structure (for example, a shape of the dielectric unit (122) is the same as a shape of the metal unit (121), and the dielectric unit (122) is disposed on an inner surface of the metal unit (121)), and a gap between any two adjacent unit structures in a plurality of unit structures is greater than or equal to 5 mm and less than or equal to 15 mm.

For ease of understanding, descriptions are provided with reference to (a) and (b) in FIG. 10. Herein, (a) and (b) in FIG. 10 are diagrams of a gap between unit structures.

It can be understood from (a) in FIG. 10 that the unit structure is a hollow cylinder, and a gap g between two adjacent unit structures is greater than or equal to 5 mm and less than or equal to 15 mm.

It can be understood from (b) in FIG. 10 that the unit structure is in a spiral shape, and a gap g between two adjacent unit structures is greater than or equal to 5 mm and less than or equal to 15 mm.

It should be noted that (a) and (b) in FIG. 10 are merely examples of the gap between the unit structures, and do not constitute any limitation on the scope of the embodiments. For example, the unit structure may alternatively be in another shape (for example, the shape shown in (b), (d), (e), or (f) in FIG. 4). For example, a size of the gap between the unit structures may be outside the range of greater than or equal to 5 mm and less than or equal to 15 mm. Examples are not given one by one for description herein.

For example, a size of the gap between two adjacent unit structures is greater than or equal to 5 mm and less than or equal to 15 mm and may be further adjusted based on a needed operating frequency band. The following provides descriptions with reference to specific examples (such as Examples 1 to 4 below). Details are not described herein.

In a possible implementation, a length of the metal unit (121) is related to an operating frequency band of a cable.

When a quantity of dielectric units (122) is equal to a quantity of metal units (121), a length of the dielectric unit (122) is related to the operating frequency band of the cable.

The operating frequency band of the cable includes at least one of the following:
1400 MHz to 2690 MHz, 3300 MHz to 3800 MHz, 4800 MHz to 5000 MHz, or 6425 MHz to 7125 MHz.

For example, for the metal unit (121), a length is greater than or equal to 10 mm and less than or equal to 40 mm, and a thickness is greater than or equal to 5 mm and less than or equal to 30 mm.

When the quantity of the dielectric units (122) is equal to the quantity of the metal units (121), for the dielectric unit (122), a length is greater than or equal to 10 mm and less than or equal to 40 mm, and a thickness is greater than or equal to 5 mm and less than or equal to 30 mm.

For example, one metal unit (121) and one dielectric unit (122) form a unit structure (for example, a shape of the dielectric unit (122) is the same as a shape of the metal unit (121), and the dielectric unit (122) is disposed on an inner surface of the metal unit (121)). For any one of the plurality of unit structures, a length is greater than or equal to 10 mm and less than or equal to 40 mm, and a thickness is greater than or equal to 5 mm and less than or equal to 30 mm.

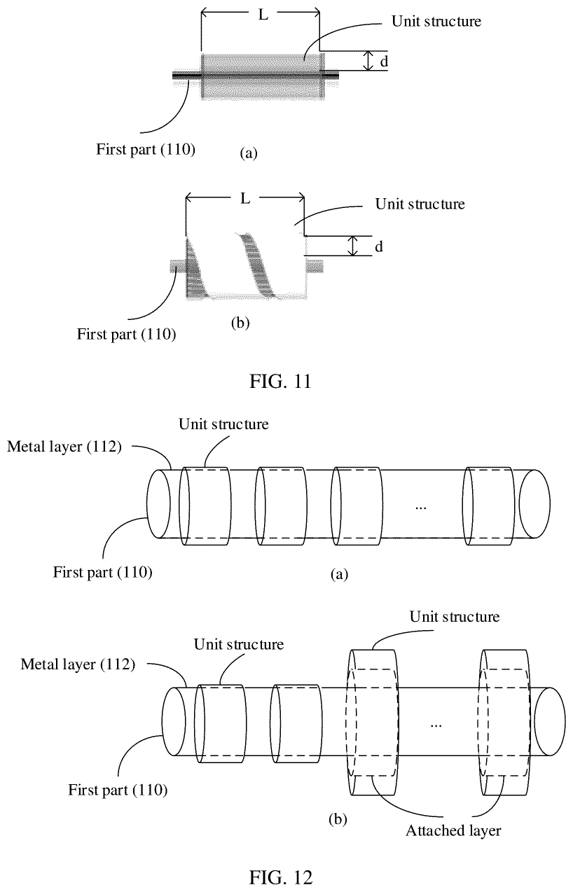

For case of understanding, descriptions are provided with reference to (a) and (b) in FIG. 11. Herein, (a) and (b) in FIG. 11 are diagrams of a size of a unit structure.

It can be understood from (a) in FIG. 11 that the unit structure is a hollow cylinder. For the unit structure, a length L is greater than or equal to 10 mm and less than or equal to 40 mm, and a thickness d is greater than or equal to 5 mm and less than or equal to 30 mm.

It can be understood from (b) in FIG. 11 that the unit structure is in a spiral shape. For the unit structure, a length L is greater than or equal to 10 mm and less than or equal to 40 mm, and a thickness d is greater than or equal to 5 mm and less than or equal to 30 mm.

It should be noted that (a) and (b) in FIG. 11 are merely examples of the gap between the unit structures, and do not constitute any limitation on the scope of the embodiments. For example, the unit structure may be in another shape (for example, the shape shown in (b), (d), (c), or (f) in FIG. 4). For example, for the unit structure, the length may be outside the range of greater than or equal to 10 mm and less than or equal to 40 mm, and/or the thickness may be outside the range of greater than or equal to 5 mm and less than or equal to 30 mm. Examples are not given one by one for description herein.

For example, for the unit structure, the length is in the range of greater than or equal to 10 mm and less than or equal to 40 mm, and the thickness is in the range of greater than or equal to 5 mm and less than or equal to 30 mm. This may be further adjusted based on a needed operating frequency band. The following provides descriptions with reference to specific examples (such as Examples 1 to 4 below), and details are not described herein.

In a possible implementation, the foregoing plurality of metal units (121) are located on a same horizontal line (for example, located at a same layer), or the foregoing plurality of metal units (121) may be located on different horizontal lines (for example, located at different layers).

For example, one metal unit (121) and one dielectric unit (122) form a unit structure. For case of understanding, descriptions are provided with reference to (a) and (b) in FIG. 12. Herein, (a) and (b) in FIG. 12 are diagrams of a horizontal location of a unit structure.

It can be understood from (a) in FIG. 12 that a plurality of unit structures are located on a same horizontal line. For example, the plurality of unit structures are all arranged in close contact with the metal layer (112).

It can be understood from (b) in FIG. 12 that a plurality of unit structures are located on different horizontal lines. For example, some of the plurality of unit structures are in close contact with the metal layer (112), and an attached layer (for example, another attached metal layer and/or dielectric layer) may be further disposed between the rest unit structures and the metal layer (112).

It should be noted that (a) and (b) in FIG. 12 are merely examples for describing whether the unit structure is located on a horizontal line, and do not constitute any limitation on the scope of the embodiments. For example, the unit structure may alternatively be in another shape (for example, the shape shown in (b), (d), (c), or (f) in FIG. 4). For example, there may be another case for the attached layer between the unit structures and the metal layer (112).

In a possible implementation, the foregoing dielectric layer (113) may be an air layer (113) sandwiched between the cable core (111) and the metal layer (112). In other words, the dielectric layer (113) does not need to be additionally manufactured and may be formed naturally by a gap between the cable core (111) and the metal layer (112). When the dielectric layer (113) is the air layer (113), production costs of the cable are reduced.

For example, the metal layer (112) is a metal sleeve, which is sleeved on the cable core (111), and a gap exists between the metal sleeve and the cable core (111).

In another possible implementation, the dielectric layer (113) may be a dielectric layer (113) that is made of a first dielectric and disposed between the cable core (111) and the metal layer (112). In other words, the dielectric layer (113) may be additionally manufactured. This facilitates stability and assembly of the cable.

For example, the first dielectric may be a Teflon (Teflon) material, or may be another insulation material, for example, plastic, ceramic, or glass.

For example, the cable provided in the embodiments is applied to the scenario shown in FIG. 1(a) to FIG. 1(d). The following describes, with reference to specific examples, the cable provided in the embodiments in improving performance in an antenna radiation pattern.

Example 1: In this embodiment, the foregoing cable needs to be used in cooperation with an active antenna array whose operating frequency band is 1400 MHz to 2690 MHz, to avoid a pattern distortion of the active antenna array whose operating frequency band is 1400 MHz to 2690 MHz.

For case of understanding, the following uses an example in which one metal unit (121) and one dielectric unit (122) form a unit structure (for example, a shape of the dielectric unit (122) is the same as a shape of the metal unit (121), and the dielectric unit (122) is disposed on an inner surface of the metal unit (121)) for description.

It can be understood from the foregoing that the operating frequency band of the cable may be adjusted by adjusting the size of the unit structure, or the operating frequency band of the cable may be adjusted by adjusting the size of the gap between the unit structures.

In this example, a possible implementation is as follows: A size of the foregoing unit structure is designed, so that the operating frequency band of the cable is the same as an operating frequency band of the active antenna array. In other words, the operating frequency band of the cable is 1400 MHz to 2690 MHz. This implements bandpass of an electromagnetic wave in the frequency band of 1400 MHz to 2690 MHz by the cable and reduces cable's shielding on the electromagnetic wave in the frequency band of 1400 MHz to 2690 MHz, thereby achieving an objective of preserving the pattern of the active antenna array.

For example, for the unit structure, a length is greater than or equal to 28 mm and less than or equal to 40 mm, and a thickness is greater than or equal to 14 mm and less than or equal to 30 mm.

For example, designing a size of the unit structure may be: adjusting, based on a distortion degree of the pattern of the active antenna array, in a length range of greater than or equal to 10 mm and less than or equal to 40 mm and a thickness range of greater than or equal to 5 mm and less than or equal to 30 mm, the size of the unit structure, and determining a value range of a length and a value rang of a thickness of the unit structure, so that the pattern of the active antenna array meets a distortion requirement (for example, a distortion amount is less than a preset threshold). In another possible implementation, a size of a gap between the foregoing unit structures is designed, so that the operating frequency band of the cable is the same as an operating frequency band of the active antenna array. In other words, the operating frequency band of the cable is 1400 MHz to 2690 MHz. This implements bandpass of an electromagnetic wave in the frequency band of 1400 MHz to 2690 MHz by the cable and reduces cable's shielding on the electromagnetic wave in the frequency band of 1400 MHz to 2690 MHz, thereby achieving an objective of preserving the pattern of the active antenna array.

For example, a gap between any two adjacent unit structures in a plurality of unit structures is greater than or equal to 10 mm and less than or equal to 15 mm.

For example, designing the gap between the unit structures may be: adjusting, based on a distortion degree of the pattern of the active antenna array, in a range of the gap between two adjacent unit structures of greater than or equal to 5 mm and less than or equal to 15 mm, the size of the gap between the two adjacent unit structures, and determining a value range of the size of the gap between the two adjacent unit structures, so that the pattern of the active antenna array meets a distortion requirement (for example, a distortion amount is less than a preset threshold).

Example 2: In this embodiment, the foregoing cable needs to be used in cooperation with an active antenna array whose operating frequency band is 3300 MHz to 3800 MHz, to avoid a pattern distortion of the active antenna array whose operating frequency band is 3300 MHz to 3800 MHz.

For ease of understanding, the following uses an example in which one metal unit (121) and one dielectric unit (122) form a unit structure (for example, a shape of the dielectric unit (122) is the same as a shape of the metal unit (121), and the dielectric unit (122) is disposed on an inner surface of the metal unit (121)) for description.

In this example, a possible implementation is as follows: A size of the foregoing unit structure is designed, so that the operating frequency band of the cable is the same as an operating frequency band of the active antenna array. In other words, the operating frequency band of the cable is 3300 MHz to 3800 MHz. This implements bandpass of an electromagnetic wave in the frequency band of 3300 MHz to 3800 MHz by the cable and reduces cable's shielding on the electromagnetic wave in the frequency band of 3300 MHz to 3800 MHz, thereby achieving an objective of preserving the pattern of the active antenna array.

For example, for the unit structure, a length is greater than or equal to 16 mm and less than or equal to 25 mm, and a thickness is greater than or equal to 8 mm and less than or equal to 14 mm.

For example, designing a size of the unit structure may be: adjusting, based on a distortion degree of the pattern of the active antenna array, in a length range of greater than or equal to 10 mm and less than or equal to 40 mm and a thickness range of greater than or equal to 5 mm and less than or equal to 30 mm, the size of the unit structure, and determining a value range of a length and a value rang of a thickness of the unit structure, so that the pattern of the active antenna array meets a distortion requirement (for example, a distortion amount is less than a preset threshold).

In another possible implementation, a size of a gap between the foregoing unit structures is designed, so that the operating frequency band of the cable is the same as an operating frequency band of the active antenna array. In other words, the operating frequency band of the cable is 3300 MHz to 3800 MHz. This implements bandpass of an electromagnetic wave in the frequency band of 3300 MHz to 3800 MHz by the cable and reduces cable's shielding on the electromagnetic wave in the frequency band of 3300 MHz to 3800 MHz, thereby achieving an objective of preserving the pattern of the active antenna array.

For example, a gap between any two adjacent unit structures in a plurality of unit structures is greater than or equal to 8 mm and less than or equal to 14 mm.

For example, designing the gap between the unit structures may be: adjusting, based on a distortion degree of the pattern of the active antenna array, in a range of the gap between two adjacent unit structures of greater than or equal to 5 mm and less than or equal to 15 mm, the size of the gap between the two adjacent unit structures, and determining a value range of the size of the gap between the two adjacent unit structures, so that the pattern of the active antenna array meets a distortion requirement (for example, a distortion amount is less than a preset threshold).

Example 3: In this embodiment, the foregoing cable needs to be used in cooperation with an active antenna array whose operating frequency band is 4800 MHz to 5000 MHz, to avoid a pattern distortion of the active antenna array whose operating frequency band is 4800 MHz to 5000 MHz.

For ease of understanding, the following uses an example in which one metal unit (121) and one dielectric unit (122) form a unit structure (for example, a shape of the dielectric unit (122) is the same as a shape of the metal unit (121), and the dielectric unit (122) is disposed on an inner surface of the metal unit (121)) for description.

In this example, a possible implementation is as follows: A size of the foregoing unit structure is designed, so that the operating frequency band of the cable is the same as an operating frequency band of the active antenna array. In other words, the operating frequency band of the cable is 4800 MHz to 5000 MHz. This implements bandpass of an electromagnetic wave in the frequency band of 4800 MHz to 5000 MHz by the cable and reduces cable's shielding on the electromagnetic wave in the frequency band of 4800 MHz to 5000 MHz, thereby achieving an objective of preserving the pattern of the active antenna array.

For example, for the unit structure, a length is greater than or equal to 10 mm and less than or equal to 18 mm, and a thickness is greater than or equal to 5 mm and less than or equal to 12 mm.

For example, designing a size of the unit structure may be: adjusting, based on a distortion degree of the pattern of the active antenna array, in a length range of greater than or equal to 10 mm and less than or equal to 40 mm and a thickness range of greater than or equal to 5 mm and less than or equal to 30 mm, the size of the unit structure, and determining a value range of a length and a value rang of a thickness of the unit structure, so that the pattern of the active antenna array meets a distortion requirement (for example, a distortion amount is less than a preset threshold).

In another possible implementation, a size of a gap between the foregoing unit structures is designed, so that the operating frequency band of the cable is the same as an operating frequency band of the active antenna array. In other words, the operating frequency band of the cable is 4800 MHz to 5000 MHz. This implements bandpass of an electromagnetic wave in the frequency band of 4800 MHz to 5000 MHz by the cable and reduces cable's shielding on the electromagnetic wave in the frequency band of 4800 MHz to 5000 MHz, thereby achieving an objective of preserving the pattern of the active antenna array.

For example, a gap between any two adjacent unit structures in a plurality of unit structures is greater than or equal to 5 mm and less than or equal to 10 mm.

For example, designing the gap between the unit structures may be: adjusting, based on a distortion degree of the pattern of the active antenna array, in a range of the gap between two adjacent unit structures of greater than or equal to 5 mm and less than or equal to 15 mm, the size of the gap between the two adjacent unit structures, and determining a value range of the size of the gap between the two adjacent unit structures, so that the pattern of the active antenna array meets a distortion requirement (for example, a distortion amount is less than a preset threshold).

Example 4: In this embodiment, the foregoing cable needs to be used in cooperation with an active antenna array whose operating frequency band is 6425 MHz to 7125 MHz, to avoid a pattern distortion of the active antenna array whose operating frequency band is 6425 MHz to 7125 MHz.

For ease of understanding, the following uses an example in which one metal unit (121) and one dielectric unit (122) form a unit structure (for example, a shape of the dielectric unit (122) is the same as a shape of the metal unit (121), and the dielectric unit (122) is disposed on an inner surface of the metal unit (121)) for description.

In this example, a possible implementation is as follows: A size of the foregoing unit structure is designed, so that the operating frequency band of the cable is the same as an operating frequency band of the active antenna array. In other words, the operating frequency band of the cable is 6425 MHz to 7125 MHz. This implements bandpass of an electromagnetic wave in the frequency band of 6425 MHz to 7125 MHz by the cable and reduces cable's shielding on the electromagnetic wave in the frequency band of 6425 MHz to 7125 MHz, thereby achieving an objective of preserving the pattern of the active antenna array.

For example, for the unit structure, a length is greater than or equal to 10 mm and less than or equal to 15 mm, and a thickness is greater than or equal to 5 mm and less than or equal to 8 mm.

For example, designing a size of the unit structure may be: adjusting, based on a distortion degree of the pattern of the active antenna array, in a length range of greater than or equal to 10 mm and less than or equal to 40 mm and a thickness range of greater than or equal to 5 mm and less than or equal to 30 mm, the size of the unit structure, and determining a value range of a length and a value rang of a thickness of the unit structure, so that the pattern of the active antenna array meets a distortion requirement (for example, a distortion amount is less than a preset threshold).

In another possible implementation, a size of a gap between the foregoing unit structures is designed, so that the operating frequency band of the cable is the same as an operating frequency band of the active antenna array. In other words, the operating frequency band of the cable is 6425 MHz to 7125 MHz. This implements bandpass of an electromagnetic wave in the frequency band of 6425 MHz to 7125 MHz by the cable and reduces cable's shielding on the electromagnetic wave in the frequency band of 6425 MHz to 7125 MHz, thereby achieving an objective of preserving the pattern of the active antenna array.

For example, a gap between any two adjacent unit structures in a plurality of unit structures is greater than or equal to 5 mm and less than or equal to 8 mm.

For example, designing the gap between the unit structures may be: adjusting, based on a distortion degree of the pattern of the active antenna array, in a range of the gap between two adjacent unit structures of greater than or equal to 5 mm and less than or equal to 15 mm, the size of the gap between the two adjacent unit structures, and determining a value range of the size of the gap between the two adjacent unit structures, so that the pattern of the active antenna array meets a distortion requirement (for example, a distortion amount is less than a preset threshold).

It should be understood that the foregoing is merely examples for describing a fact that different cables can be designed based on requirements and does not constitute any limitation on the scope of the embodiments. Alternatively, a cable of another different operating frequency band may be designed based on an operating frequency band of a device used in cooperation with the cable. Examples are not given one by one for description herein.

It should be noted that the foregoing uses how to reduce cable's shielding on the electromagnetic wave in the specific frequency band as an example for description. The second part (120) can be added to the common cable shown above, and the second part (120) can alternatively be added to another device, to reduce shielding, by the device, on an electromagnetic wave in a specific frequency band. For example, the foregoing first part (110) may be a metal component, for example, a common metal pole. Examples are not given one by one for description in the embodiments.

The foregoing descriptions are merely specific of the embodiments but are not intended as limiting. Any variation or replacement readily figured out by a person skilled in the art shall fall within the scope of the embodiments.

1. A cable comprising:
a first part and a second part, wherein
the first part comprises a cable core, a metal layer, and a dielectric layer;
the metal layer wraps the cable core, and the dielectric layer is sandwiched between the cable core and the metal layer;
the second part comprises a plurality of metal units and a dielectric unit; and
the plurality of metal units is spacedly disposed on the metal layer, and the dielectric unit is sandwiched between the plurality of metal units and the metal layer.

2. The cable according to claim 1, further comprising:
a plurality of dielectric units, wherein a quantity of the plurality of dielectric units is equal to a quantity of the plurality of metal units, and one of the plurality of dielectric units is sandwiched between one of the plurality of metal units and the metal layer.

3. The cable according to claim 1, wherein there is one dielectric unit, and the dielectric unit wraps the metal layer, and is disposed between the plurality of metal units and the metal layer.

4. The cable according to claim 1, wherein a first metal unit of the plurality of metal units is disposed on a first annular area of the metal layer; and
the first metal unit at least partially covers the first annular area.

5. The cable according to claim 4, wherein a shape of the first metal unit comprises a circular ring shape or a spiral shape.

6. The cable according to claim 1, wherein the plurality of metal units being spacedly disposed on the metal layer comprises:
the plurality of metal units is equally spaced on the metal layer.

7. The cable according to claim 2, wherein a gap between any two adjacent metal units in the plurality of metal units is greater than or equal to 5 mm and less than or equal to 15 mm; and
when the quantity of the dielectric units is equal to the quantity of the metal units, a gap between any two adjacent dielectric units in the plurality of dielectric units is greater than or equal to 5 mm and less than or equal to 15 mm.

8. The cable according to claim 2, wherein a length of each metal unit is related to an operating frequency band of the cable;
when the quantity of the plurality of dielectric units is equal to the quantity of the plurality of metal units, a length of each dielectric unit is related to the operating frequency band of the cable; and
the operating frequency band of the cable is at least one of the following:
1400 MHz to 2690 MHz, 3300 MHz to 3800 MHz, 4800 MHz to 5000 MHz, or 6425 MHz to 7125 MHz.

9. The cable according to claim 8, wherein, for each metal unit, the length is greater than or equal to 10 mm and less than or equal to 40 mm, and a thickness is greater than or equal to 5 mm and less than or equal to 30 mm; and
when the quantity of the plurality of dielectric units is equal to the quantity of the plurality of metal units, for each dielectric unit, the length is greater than or equal to 10 mm and less than or equal to 40 mm, and a thickness is greater than or equal to 5 mm and less than or equal to 30 mm.

10. The cable according to claim 2, wherein at least two of the plurality of metal units are the same; and
when the quantity of the plurality of dielectric units is equal to the quantity of the plurality of metal units, and at least two of the plurality of dielectric units are the same.

11. The cable according to claim 1, wherein the cable comprises a coaxial cable.

12. The cable according to claim 1, wherein the plurality of metal units is located at a same layer.

13. A communication system; comprising:
a cable and a first antenna array, wherein the cable is located on a radiation path of the first antenna array; and
the cable comprises:
a first part and a second part, wherein
the first part comprises a cable core, a metal layer, and a dielectric layer;
the metal layer wraps the cable core, and the dielectric layer is sandwiched between the cable core and the metal layer;
the second part comprises a plurality of metal units and a dielectric unit; and
the plurality of metal units is spacedly disposed on the metal layer, and the dielectric unit is sandwiched between the plurality of metal units and the metal layer.

14. The communication system according to claim 13, further comprising a second antenna array,
the first antenna array comprises a first receive antenna module, a low noise amplification module, and a power supply module, and
the second antenna array comprises a second receive antenna module.

15. The communication system according to claim 13, further comprising:
a plurality of dielectric units, wherein a quantity of the plurality of dielectric units is equal to a quantity of the plurality of metal units, and one of the plurality of dielectric units is sandwiched between one of the plurality of metal units and the metal layer.

16. The communication system according to claim 13, wherein there is one dielectric unit, and the dielectric unit wraps the metal layer, and is disposed between the plurality of metal units and the metal layer.

17. The communication system according to claim 13, wherein a first metal unit of the plurality of metal units is disposed on a first annular area of the metal layer; and
the first metal unit completely or partially covers the first annular area.

18. The communication system according to claim 13, wherein a shape of the metal unit comprises a circular ring shape or a spiral shape.

19. The communication system according to claim 13, wherein the plurality of metal units being spacedly disposed on the metal layer comprises:
the plurality of metal units is equally spaced on the metal layer.

20. The communication system according to claim 15, wherein a gap between any two adjacent metal units in the plurality of metal units is greater than or equal to 5 mm and less than or equal to 15 mm; and
when the quantity of the plurality of dielectric units is equal to the quantity of the plurality of metal units, a gap between any two adjacent dielectric units in the plurality of dielectric units is greater than or equal to 5 mm and less than or equal to 15 mm.
